(19) United States
(12) Patent Application Publication
(10) Pub. No.: US 2025/0279746 A1
(43) Pub. Date: Sep. 4, 2025

(54) ARTICULATING SOLAR ARRAYS AND METHODS

(71) Applicant: Helical Solar Solutions, LLC, Leander, TX (US)

(72) Inventors: James McKinion, Horseshoe Bay, TX (US); Keith Becker, Cedar Park, TX (US)

(73) Assignee: Helical Solar Solutions, LLC, Leander, TX (US)

(21) Appl. No.: 19/069,934

(22) Filed: Mar. 4, 2025

Related U.S. Application Data
(60) Provisional application No. 63/560,970, filed on Mar. 4, 2024.

(51) Int. Cl. H02S 30/20; F16M 11/20; H02S 10/40

(52) U.S. Cl. CPC H02S 30/20; F16M 11/2021; H02S 10/40

(57) ABSTRACT

A solar array includes an elongate support having a proximal end and a distal end, a slew drive coupled to the distal end of the elongate support, and first and second pivotally coupled leaves of solar panels, where the first leaf is coupled to the slew drive. In some examples, the solar array further includes a base coupled to the proximal end of the elongate support, and optionally, at least one energy storage system.

### BACKGROUND OF THE INVENTION

The present application relates in general to articulating solar arrays and associated methods.

Solar energy has become increasingly important as a renewable energy source. A typical solar power system includes one or more photovoltaic (PVT) solar panels, which may have associated battery storage. Although fixed solar installations, such as rooftop solar panel arrays, have been utilized for many years, articulating solar arrays in which the solar panels move relative to one another and transportable solar arrays are the subject of more recent developments.

### SUMMARY OF THE INVENTION

The design of articulating and/or transportable solar power systems can include many design challenges. For example, to achieve sufficient durability the solar panels of the solar power system must be protected from damage during transport and/or when deployed (e.g., during high wind events). Further, deployment reliability requires the mechanisms that facilitate articulation of the solar panels to repeatedly move between different configurations of the solar panels without failure. Another design challenge for articulating and/or transportable solar power systems is space efficiency. To be practical, an articulating and/or transportable solar power system should be able to achieve a compact configuration compatible with available modes of transport.

In at least some embodiments, these and other design challenges are met in a transportable articulating solar array.

In at least some embodiments, a solar array includes an elongate support having a proximal end and a distal end, a slew drive coupled to the distal end of the elongate support, and first and second pivotally coupled leaves of solar panels. The first leaf is coupled to the slew drive. In some examples, the solar array further includes a base coupled to the proximal end of the elongate support, and optionally, at least one energy storage system.

In at least some embodiments, a method includes transporting, to a deployment site, a solar array including an elongate support having a proximal end and a distal end, a slew drive coupled to the distal end of the elongate support, and first and second pivotally coupled leaves of solar panels, where the first leaf is coupled to the slew drive. The solar array is then deployed at the deployment site. In some examples, the solar array includes a load-bearing surface, and deploying the solar array includes rotating the first leaf by the slew drive while supporting the second leaf on the load-bearing surface and thereafter rigidly coupling the first and second leaves in co-planar relation.

### BRIEF DESCRIPTION OF THE DRAWINGS

FIG. 1 is a first perspective view of an exemplary articulating solar array in a folded configuration in accordance with one or more embodiments;

FIG. 2 is a second perspective view of an exemplary articulating solar array in a folded configuration in accordance with one or more embodiments;

FIG. 3 is a first elevation view of an exemplary articulating solar array in a folded configuration in accordance with one or more embodiments;

FIG. 4 is a second elevation view of an exemplary articulating solar array in a folded configuration in accordance with one or more embodiments;

FIG. 5 is a high-level logical flowchart of an exemplary process for deploying an articulating solar array in accordance with one or more embodiments;

FIGS. 6A-6B are third and fourth elevation views of an exemplary articulating solar array pivoted with respect to its base and in an unfolding configuration in accordance with one or more embodiments;

FIG. 7 is a fifth elevation view of an exemplary articulating solar array pivoted with respect to its base and in an unfolded configuration in accordance with one or more embodiments;

FIG. 8 illustrates an exemplary mobile articulating solar array in an open configuration in accordance with one or more embodiments;

FIG. 9 depicts an exemplary transport fixture for securing a mobile articulating solar array during transport in accordance with one or more embodiments;

FIG. 10 depicts the exemplary transport fixture of FIG. 9 with a mobile articulating solar array during transport in accordance with one or more embodiments; and

FIG. 11 illustrates an exemplary vehicle for transporting multiple mobile articulating solar arrays in accordance with one or more embodiments.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

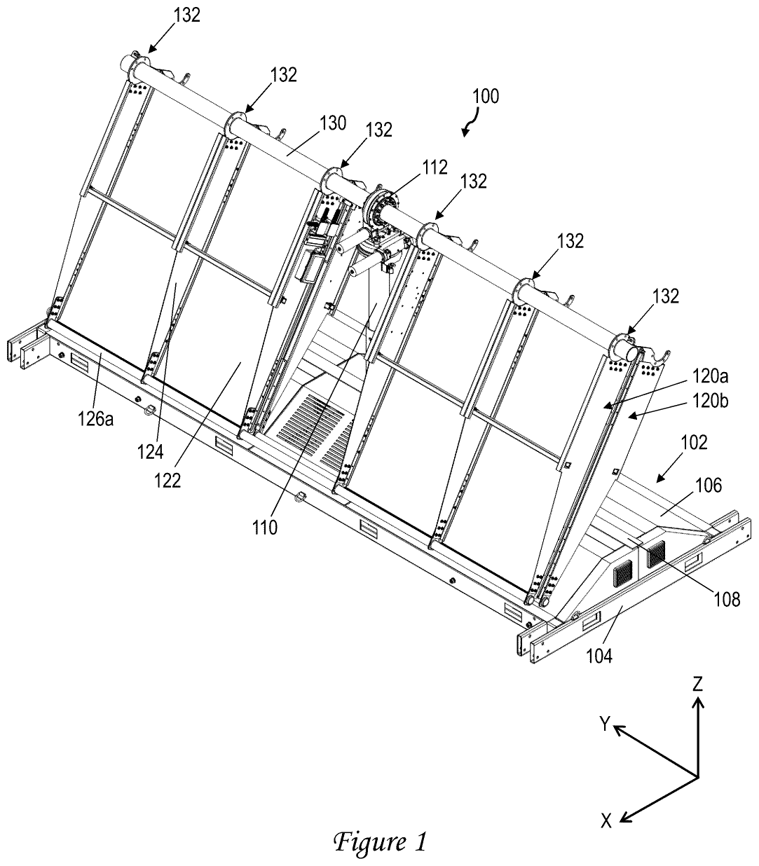

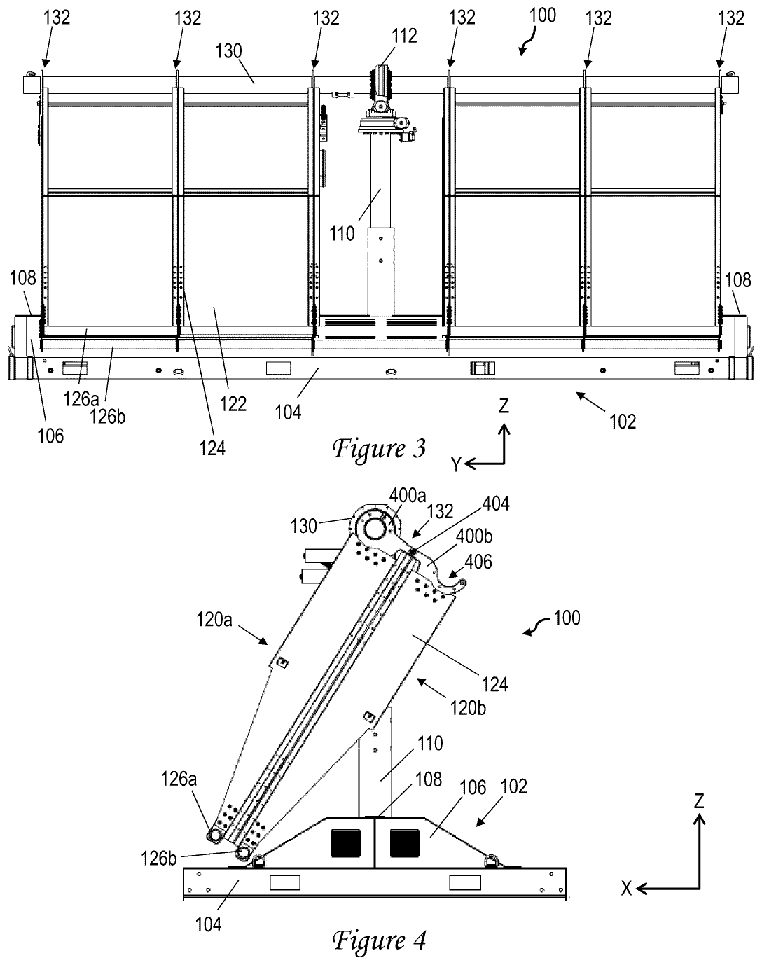

Referring now to FIGS. 1 through 4, there are illustrated first and second perspective views and first and second elevation views of an exemplary transportable articulating solar array 100 in accordance with one or more embodiments. FIGS. 1-4 depict solar array 100 in a folded configuration with reference to a 3-dimensional coordinate system including orthogonal X, Y, and Z axes.

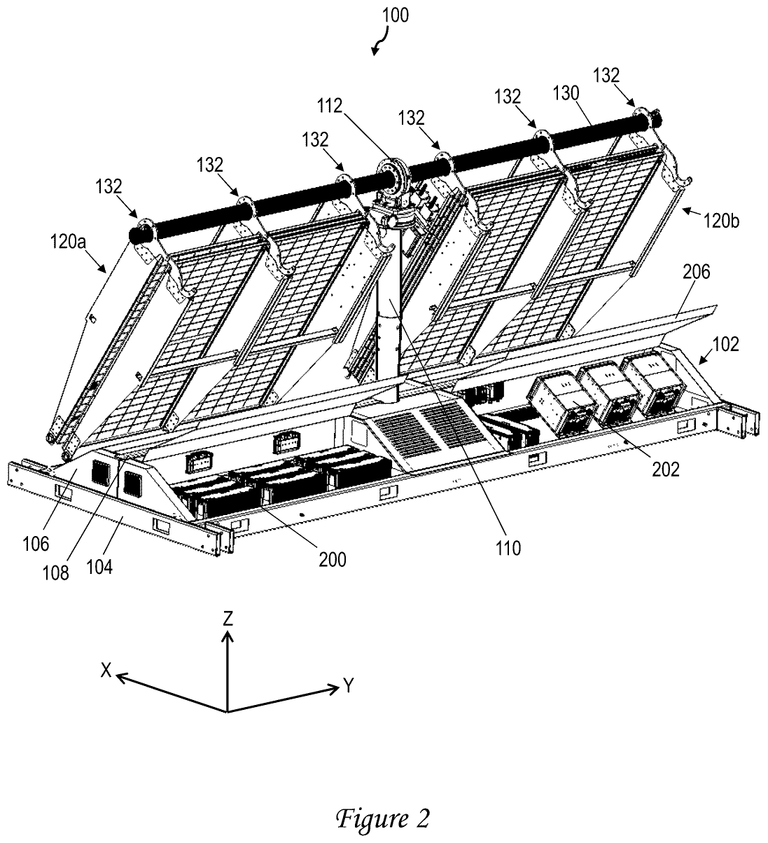

In the illustrated embodiment, solar array 100 includes a base 102, which in this example includes a frame 104, for example, of steel or other durable rigid material, and an optional cabinet 106 for housing power converters 200, one or more energy storage systems 202 (e.g., batteries, fuel cells, super-capacitors) for storing power generated by solar array 100, and optionally, other components of solar array 100. The components of solar array 100 housed in cabinet 106 advantageously provide ballast to base 102 that promotes stability and resists overturning. As best seen in FIG. 2, cabinet 106 can include pivotal and/or removable doors 206 that be manually opened to permit access to the components housed within cabinet 106.

Frame 104 can be configured as required or desired to support solar array 100 on an underlying surface at a deployment location. For example, if solar array 100 is intended for deployment on a substantially planar substrate, the lower surface of frame 104 can be substantially planar in the X-Y plane. The dimensions and mass of base 102 are preferably designed to resist overturning of solar array 100 when subjected to a maximum rated wind speed. Further, the dimensions and mass of base 102 can be selected to enable transport of solar array 100 via a desired mode of transport, such as by truck, trailer, rail, or aircraft. In one example, base 102 extends along X axis less than or equal to 102 inches and extends along Y axis less than 264 inches. In this example, solar array 100 fits within a contiguous form factor of three 463L US military master pallets. In at least some embodiments, an upper surface of base 102 is configured as a load-bearing surface 108 to support at least one leaf of solar array 100 while solar array 100 is being unfolded (opened). In such embodiments, an upper surface of base 102 (or a lower edge of a leaf of solar array 100) preferably includes a low friction contact surface, such as an ultra-high-molecular-weight (UHMW) load bearing material (e.g., McMaster-Carr 9542K342) or one or more rollers.

Coupled to a central portion of base 102 is an elongate support 110 extending along the Z axis between a proximal end rigidly coupled to base 102 and an opposing distal end. Elongate support 110 can be implemented, for example, by a metal pipe or tube having a suitable diameter and wall thickness for its intended load. For example, in one implementation, elongate support 110 can include a nominal 8 inch round or square steel pipe (e.g., Schedule 40 pipe having a 0.322 inch wall thickness). In some embodiments, elongate support 110 can includes multiple sections that can be removably coupled (e.g., by bolts) to each other and to base 102. In one example, the length of elongate support 110 is selected such that the maximum extension of solar array 100 along the Z axis when in the folded configuration shown in FIGS. 1-4 is less than or equal to 102 inches, which is the maximum US interstate highway shipping dimensions for unpermitted loads carried by flatbed tractor trailers. In some embodiments, the maximum extension of solar array 100 along the Z axis in the folded configuration is less than 107 inches.

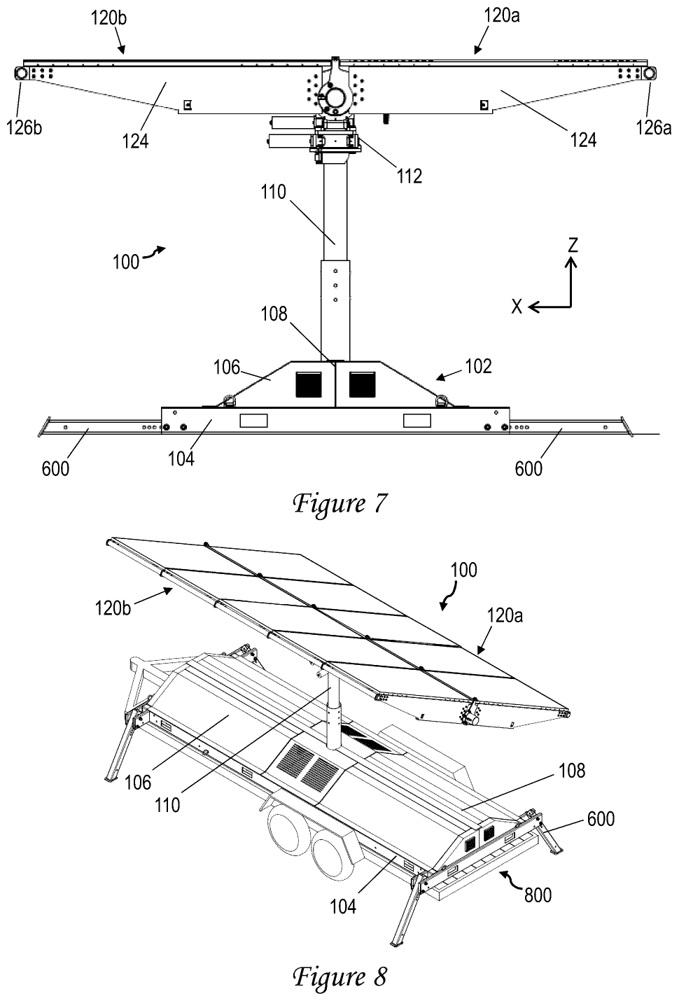

A dual-axis slew drive 112 is coupled to the distal end of elongate support 110. Slew drive 112 is capable of movement in both azimuth (X-Y planes) and elevation (X-Z planes). In one example, slew drive 112 has an elevation output torque of 4270 N·m at 0.082 rpm and an azimuth output torque of 4880 N·m at 0.082 rpm, allowing the leaves of solar array 100 to be articulated in both azimuth and elevation in the folded (or closed) configuration illustrated in FIGS. 1-4, the unfolded (or open) configuration depicted in FIG. 7, or any intermediate configuration. As is known in the art, the operation of slew drive 112 can be controlled by a drive controller, which can include a umbilically or wirelessly connected manual controller (e.g., joystick or push-button controller), and/or a software-based controller, which can execute on a stand-alone platform (e.g., laptop computer, tablet, mobile phone, remote network-connected computer, etc.) or on an on-board platform (e.g., housed in cabinet 106 or mounted on a purlin 124).

In the illustrated embodiment, solar array 100 includes multiple movable leaves 120a, 120b. Each leaf 120a or 120b includes a plurality of solar panels supported by a frame. In this example, each leaf 120a or 120b includes four or five bi-facial utility-scale solar panels 122 supported by a frame including six purlins (or ribs) 124 and a respective crossbar 126a or 126b linking its purlins 124. Suitable solar panels that are commercially available include, for example, JAM72D30_525-550 MB available from JA Solar USA Inc., S4A580-144NH10 available from the Solar4America division of SPI Energy Co., Ltd., and YSM-B-540W available from Yotta Energy Inc. Purlins 124 of leaf 120a are rigidly coupled to an elongate torque tube 130, which is in turn rigidly and symmetrically coupled (e.g., bolted) to slew drive 112.

In the exemplary embodiment, leaves 120a, 120b are coupled to each other along adjoining edges by one or more hinges 132, each including a first hinge member 400a coupled to leaf 120a, a second hinge member 400b coupled to leaf 120b, and a hinge axis 404 (e.g., hinge pin) about which first hinge member 400a and second hinge member 400b pivot. In the illustrated example, the end of each of the six purlins 124 of leaf 120a is coupled to the end of a respective corresponding purlin 124 of leaf 120b by a respective hinge 132. Each second hinge member 400b includes a recess 406 configured as a cradle for receiving a portion of torque tube 130 therein when leaves 120a, 120b are fully unfolded (opened). By virtue of the hinged coupling of leaves 120a, 120b, corresponding upper faces of the solar panels 122 of leaves 120a, 120b face each other and are closely spaced for protection of the upper faces of panels 122 when solar array 100 is configured in a folded configuration as shown in FIGS. 1-4.

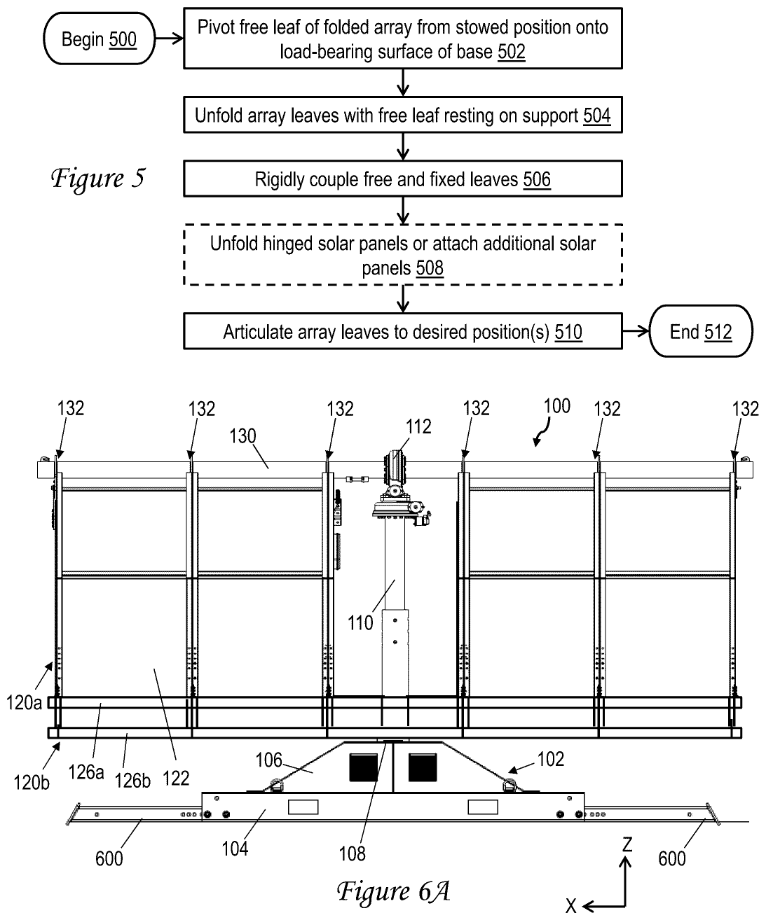

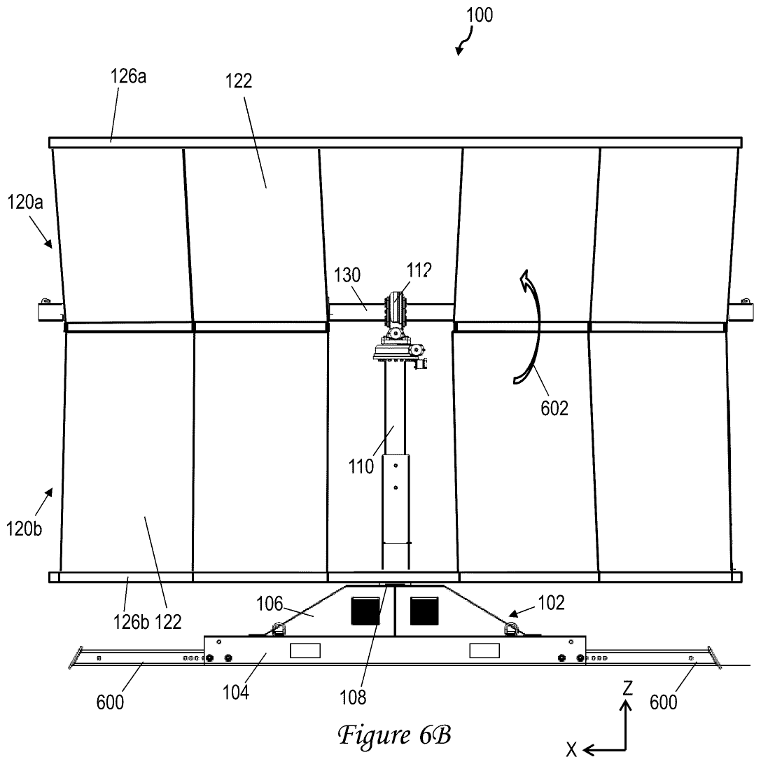

With reference now to FIG. 5, there is illustrated a high-level logical flowchart of an exemplary process for deploying an articulating solar array in accordance with one or more embodiments. The process of FIG. 5 will be described with additional reference to FIGS. 6 and 7, which are third and fourth elevation views illustrating a solar array 100 pivoted with respect to its base and shown in unfolding and unfolded configuration, respectively, in accordance with one or more embodiments.

The process of FIG. 5 begins at block 500, for example, with a solar array 100 stably located at a deployment site. As noted above and discussed further below, in at least some usc cases, solar array 100 may be transported to the deployment site, for example, by trailer, truck, rail, and/or aircraft. To stabilize solar array 100 at the deployment site, one or more outriggers may be installed or deployed to widen a footprint of base 102 (or a transport for base 102) along one or more dimensions. For example, FIGS. 6 and 7 illustrate an exemplary embodiment in which a pair of outriggers 600 are coupled (e.g., bolted) to each end of frame 104 to extend a footprint of base 102 along the X axis. Once stably located at the deployment site, solar array 100 can be articulated from the folded position shown in FIGS. 1-4 through the unfolding configurations shown in FIGS. 6A-6B to the unfolded position shown in FIG. 7 in accordance with the process of FIG. 5.

At block 502, the drive controller actuates slew drive 112 to raise and pivot a trailing surface of leaf 120b (e.g., crossbar 126b) from the stowed position depicted in FIGS. 1-4 onto load-bearing surface 108. In order to raise leaf 120b in elevation as slew drive 112 rotates torque bar 130 to raise leaf 120a, leaves 120a and 120b may be temporarily locked in a closed configuration, for example, by removably coupling leaf 120b to leaf 120a, for example, with removable fasteners, such as U-bolts coupling crossbars 126a and 126b. Once leaf 120b is resting on load-bearing surface 108, the removable coupling of leaves 120a and 120b can be removed to allow leaves 120a and 120b to freely pivot about hinge axis 404 with respect to each other.

With leaf 120b supported by load-bearing surface 108, the drive controller actuates slew drive 112 to rotate torque tube 130 and to thus rotate array leaf 120a upward in elevation along a Y-Z plane as indicated in FIG. 6B by arrow 602 (block 504). This rotation continues until leaves 120a, 120b have a desired relative angle, such as 180 degrees (i.e., with leaves 120a, 120b adjoining in co-planar relation). Because leaf 120b is coupled to leaf 120a by hinges 132 having an hinge axis 404 offset from torque tube 130, leaf 120b (i.e., crossbar 126) is driven forward and backward on load-bearing surface 108 as leaf 120a rotates upward. Resting leaf 120b on load-bearing surface 108 during the unfolding of solar array 100 in this way enhances operator safety by eliminating the risk that free leaf 120b drops or falls.

At block 506, fixed leaf 120a and free leaf 120b are rigidly coupled together at the desired relative angle, for example, with manually installed clamps, plates, and/or bolts, electrically actuated locking pins, or the like. In one exemplary embodiment, leaves 120a, 120b are rigidly coupled by bolting metal plates (e.g., hinge members 400a, 400b) spanning the one or more purlins 124 on leaves 120a, 120b. Locked together in this manner, both leaves 120a, 120b will thereafter experience the same azimuth and elevation rotation as slew drive 112 is actuated.

In some embodiments, such as that shown in FIGS. 1-4, one or more solar panels 122 are removed from one or more leaves 120 or articulated into a transportable position in order to permit solar array 100 to have compact dimensions during transport and/or to prevent damage to solar panel(s) 122, for example, due to contact with elongate support 110. For example, in the embodiment of FIGS. 1-4, two central solar panels 122 can be removed from each of leaves 120a, 120b and/or folded (e.g., via piano hinges along the long edges of solar panels 122) to rest between leaves 120a, 120b during transport. In such embodiments, the process of FIG. 5 includes an optional block 508, illustrating the step of unfolding and securing the hinged solar panel(s) 122 on one or more of leaves 120a, 120b and/or attaching one or more additional solar panels 122 to one or more of leaves 120a, 120b. After unfolding or attachment, the additional solar panel(s) 122 unfolded or attached at block 508 are preferably co-planar with the other solar panel(s) 122 of the same leaf 120.

At block 510, slew drive 112 is actuated to articulate array leaves 120 to one or more or more desired positions, such as that illustrated in FIG. 7. For example, block 510 can represent slew drive 112 implementing sun-tracking in order to optimize power generation by solar array 100. Following block 510, the process of FIG. 5 ends at block 512.

Referring now to FIG. 8, there is depicted a perspective view of an exemplary mobile articulating solar array 100 in an open configuration in accordance with one or more embodiments. FIG. 8 illustrates that a solar array 100 may be transported on and/or made integral to a trailer 800 that is towable, for example, by a truck (not illustrated). In this example, solar array 100 is stabilized by outriggers 600 extend outwardly and downwardly from frame 104 to contact an underlying surface (e.g., ground or pavement).

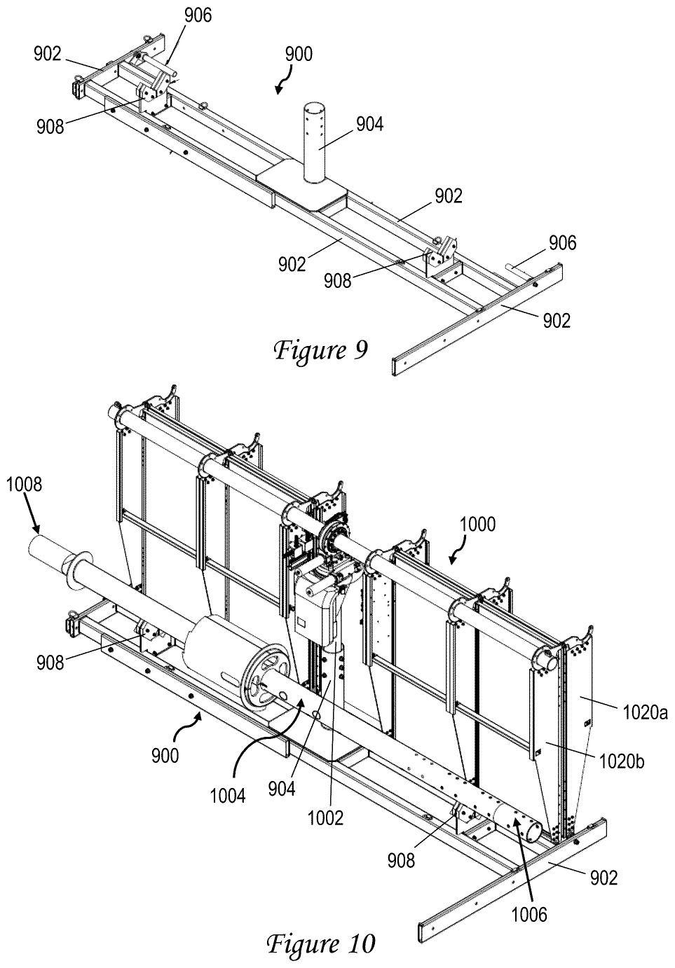

With reference now to FIGS. 9-10, there is illustrated an exemplary transport fixture 900 for securing a mobile articulating solar array during transport in accordance with one or more embodiments. In some embodiments, transport fixture 900 can be configured to be utilized as a base 102 of a solar array 100 as previously described. In other embodiments, transport fixture 900 is configured for use in transporting a mobile articulating solar array, but not for use as a base 102 of a deployed solar array.

In the illustrated example, transport fixture 900, which can be separable from, supported by, coupled to, and/or integrated with a transport vehicle, includes one or more fixture members 902 that are coupled together to form a chassis. Fixture members 902 are preferably formed of a rugged durable material, such as steel or other metal. Coupled to fixture members 902 is an array support 904, such as a metal tube configured to cooperate with and be coupled to a stem portion 1002 of the elongate support of a solar array 1000. For ease of understanding, it will be assumed that, except for base 102, solar array 1000 is similar to solar array 100 of FIG. 1-4. In the depicted example, stem portion 1002 is configured to be received within and removably coupled (e.g., bolted) to array support 904, as shown in FIG. 10. In order to restrict movement of the leaves 1020a, 1020b of solar array 1000 during transport, transport fixture 900 may additionally include one or more chassis lock pins 906, which may cooperate with (e.g., be received within the hollow interior of) one or more of the crossbars at the edges of the leaves 1020a, 1020b in order to secure the crossbar(s) with respect to the chassis.

In the exemplary embodiment, transport fixture 900 additionally includes one or more cradles 908 configured to support and/or stabilize an elongate support 1004 for solar array 1004 during transport. In the example shown in FIG. 10, cradles 908 support and stabilize an elongate support 1004 having an upper end 1006 configured to be coupled to stem portion 1002 and a lower end 1008 configured for in-ground burial.

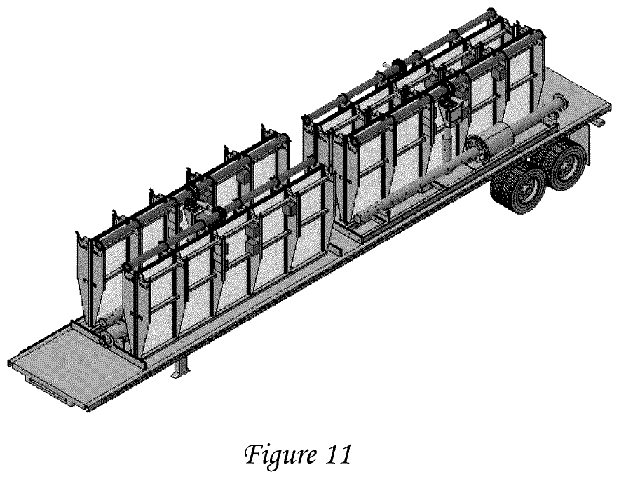

As shown in FIG. 11, transport fixtures 900 and solar arrays 1000 can be configured and sized to permit multiple solar arrays 1000 to be transported together, for example, on a flatbed tractor trailer or train car.

As has been described, in at least some embodiments, a solar array includes an elongate support having a proximal end and a distal end, a slew drive coupled to the distal end of the elongate support, and first and second pivotally coupled leaves of solar panels. The first leaf is coupled to the slew drive. In some examples, the solar array further includes a base coupled to the proximal end of the elongate support, and optionally, at least one energy storage system.

While the present invention has been particularly shown as described with reference to one or more preferred embodiments, it will be understood by those skilled in the art that various changes in form and detail may be made therein without departing from the spirit and scope of the invention. Further, features of the disclosed embodiments may be combined to form additional embodiments not specifically enumerated herein.

The following definitions are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, system or apparatus that comprises a list of elements is not necessarily limited to only those elements but can include other elements not expressly listed or inherent to such composition, mixture, process, method, article, system or apparatus.

Additionally, the term “exemplary” is used herein to mean “serving as one example, instance or illustration.” Any embodiment or design described herein as “exemplary” is not necessarily to be construed as preferred or advantageous over other embodiments or designs. The terms “at least one” and “one or more” shall be understood to include any integer number greater than or equal to one, and the term “plurality” shall be understood to include any integer number greater than or equal to two. The term “coupled” shall include both indirect connection and a direct connection, unless specified otherwise in a particular case. The terms “about,” “substantially,” “approximately,” and variations thereof, are intended to include the degree of error associated with measurement of the particular quantity based upon the equipment available at the time of filing the application. For example, “about” can include a range of ±10% or ±5%, or ±2% of a given value.

The figures described herein and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. For the sake of brevity, conventional techniques related to making and using aspects of the invention(s) may or may not be described in detail herein, and many conventional implementation details are only mentioned briefly or are omitted entirely. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A solar array, comprising:
an elongate support having a proximal end and a distal end;
a slew drive coupled to the distal end of the elongate support; and
first and second pivotally coupled leaves of solar panels, wherein the first leaf is coupled to the slew drive.

2. The solar array of claim 1, further comprising a base coupled to the proximal end of the elongate support.

3. The solar array of claim 2, wherein the base includes at least one energy storage system.

4. The solar array of claim 3, wherein the base includes a cabinet housing the energy storage system.

5. The solar array of claim 2, wherein:
the elongate support is coupled to a central portion of the base.

6. The solar array of claim 2, wherein the base includes a load-bearing surface including a low friction contact surface configured to support the second leaf.

7. The solar array of claim 2, further comprising a wheeled trailer bearing the solar array.

8. The solar array of claim 2, wherein the solar array has maximum dimensions less than or equal to 102 inches in width and 264 inches in length in a folded configuration.

9. The solar array of claim 1, wherein the first leaf is coupled to the slew drive via a torque tube symmetrically extending from the slew drive.

10. The solar array of claim 9, wherein the first and second leaves are pivotally coupled by one or more hinges having a hinge axis spaced apart from the torque tube.

11. The solar array of claim 1, wherein at least the first leaf includes a hinged solar panel rotatable with respect to a plane of the first leaf.

12. The solar array of claim 1, further comprising a transport fixture coupled to the proximal end of the elongate support.

13. The solar array of claim 12, wherein:
one of the first and second leaves includes a crossbar;
the transport fixture includes:
a chassis; and
at least one chassis lock pin coupled to the chassis and configured to cooperate with the crossbar to secure the crossbar with respect to the chassis.

14. A system, comprising:
a wheeled vehicle including a bed bearing at least one solar array in accordance with claim 12.

15. A solar array, comprising:
an elongate support having a proximal end and a distal end;
a slew drive coupled to the distal end of the elongate support;
first and second leaves of solar panels, wherein:
the first leaf is coupled to the slew drive via a torque tube symmetrically extending from the slew drive; and
the second leaf is pivotally coupled to the first leaf by one or more hinges having a hinge axis spaced apart from the torque tube;
a base having a central portion coupled to the proximal end of the elongate support, the base including a load-bearing surface configured to support a second leaf among the multiple leaves.

16. The solar array of claim 15, further comprising at least one energy storage system.

17. The solar array of claim 15, further comprising a wheeled trailer bearing the solar array.

18. A method, comprising:
transporting to a deployment site a solar array including:
an elongate support having a proximal end and a distal end;
a slew drive coupled to the distal end of the elongate support; and
first and second pivotally coupled leaves of solar panels, wherein a first leaf is coupled to the slew drive; and
deploying the solar array at the deployment site.

19. The method of claim 18, wherein the transporting includes:
transporting the solar array in a folded configuration in which corresponding faces of solar panels in the first and second leaves face each other.

20. The method of claim 18, wherein:
the solar array includes a load-bearing surface; and
the deploying includes:
rotating the first leaf by the slew drive while supporting the second leaf on the load-bearing surface; and
thereafter, rigidly coupling the first and second leaves in co-planar relation.
